(19) United States
(12) Patent Application Publication
(10) Pub. No.: US 2026/0155985 A1
(43) Pub. Date: Jun. 4, 2026

(54) CRYPTOGRAPHIC PROOF OF ELECTRONIC SIGNATURE TIMING

(71) Applicant: OneSpan Canada Inc., Montreal (CA)

(72) Inventors: Guy Harrison, Kingsville (AU); Michael Harrison, Derrimut (AU); Steven Cedro, Thomastown (AU)

(21) Appl. No.: 18/951,087

(22) Filed: Nov. 18, 2024

Related U.S. Application Data
(60) Provisional application No. 63/599,973, filed on Nov. 16, 2023.

(51) Int. Cl. H04L 9/32; H04L 9/00

(52) U.S. Cl. CPC H04L 9/3236; H04L 9/3247; H04L 9/50

(57) ABSTRACT

In an embodiment, one general aspect includes a method of cryptographically proving a time of signature. The method includes receiving an electronically signed digital document. The method also includes generating a cryptographic hash using at least a portion of the electronically signed digital document. The method also includes storing the cryptographic hash on a blockchain in a blockchain transaction. The method also includes storing, in association with the electronically signed digital document, a certification of an existence of the electronically signed digital document at a time associated with the blockchain transaction.

### CROSS-REFERENCE TO RELATED APPLICATIONS

This patent application claims priority to U.S. Provisional Application No. 63/599,973 filed on Nov. 16, 2024. U.S. Provisional Application No. 63/599,973 is hereby incorporated by reference.

### BACKGROUND

### Technical Field

The present disclosure relates generally to information security and more particularly, but not by way of limitation, to cryptographic techniques for demonstrating time of signature.

### History of Related Art

The Public Key Infrastructure (PKI), which underlies electronic signatures, currently relies upon asymmetric cryptographic algorithms that can be compromised by a sufficiently powerful quantum computer. When such a quantum computer is widely available, it is expected that the “root” certificates that underlie the majority of digital signatures will be broken, invalidating potentially millions or billions of digital agreements.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In an embodiment, one general aspect includes a method of cryptographically proving a time of signature. The method includes receiving an electronically signed digital document. The method also includes generating a cryptographic hash using at least a portion of the electronically signed digital document. The method also includes storing the cryptographic hash on a blockchain in a blockchain transaction. The method also includes storing, in association with the electronically signed digital document, a certification of an existence of the electronically signed digital document at a time associated with the blockchain transaction.

In an embodiment, another general aspect includes a computer system having a processor, persistent storage, and memory. The processor and the memory in combination are operable to implement a method of cryptographically proving a time of signature. The method includes receiving an electronically signed digital document. The method also includes generating a cryptographic hash using at least a portion of the electronically signed digital document. The method also includes storing the cryptographic hash on a blockchain in a blockchain transaction. The method also includes storing, in association with the electronically signed digital document, a certification of an existence of the electronically signed digital document at a time associated with the blockchain transaction.

In an embodiment, in another general aspect, a computer-program product includes a non-transitory computer-usable medium having computer-readable program code embodied therein. The computer-readable program code is adapted to be executed to implement a method of cryptographically proving a time of signature. The method includes receiving an electronically signed digital document. The method also includes generating a cryptographic hash using at least a portion of the electronically signed digital document. The method also includes storing the cryptographic hash on a blockchain in a blockchain transaction. The method also includes storing, in association with the electronically signed digital document, a certification of an existence of the electronically signed digital document at a time associated with the blockchain transaction.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example of a system for implementing a signature proof system;

FIG. 2 illustrates an example of a signature proof system;

FIG. 3 illustrates an example of a process for cryptographically proving a time of signature of one or more electronically signed digital documents;

FIG. 4 illustrates an example of a Merkle tree;

FIG. 5 illustrates an example of a batch Merkle tree; and

FIG. 6 illustrates an example of a computer system.

### DETAILED DESCRIPTION

### I. Overview

Digital agreements are the lifeblood of many companies and have real and significant monetary value. Electronic signature solutions such as those offered by DOCUSIGN, ONESPAN and ADOBE provide a convenient, efficient, and safe way of executing digital agreements. Electronic signatures use the same reliable, certified, and battle-tested cryptography that underpins privacy and security across the Web and supports reliable and trustworthy e-commerce.

However, the Public Key Infrastructure (PKI), which underlies electronic signatures, currently relies upon asymmetric cryptographic algorithms that can be compromised by a sufficiently powerful quantum computer. A quantum computer powerful enough to break today's digital signatures probably does not yet exist, but most experts believe that such a computer could exist within 5-10 years.

When such a quantum computer is widely available, it is expected that the “root” certificates that underlie the majority of digital signatures will be broken, invalidating potentially millions or billions of digital agreements. Although a digital signature signed today cannot be broken today, if the time span of the agreement is more than a few years, then there is a real risk that the agreement's cryptographic validity will be destroyed before the agreement terminates.

At some point before the advent of a PKI-breaking quantum computer (popularly known as Q-Day), PKI will be updated to use quantum-safe algorithms. However, in the meantime, millions of digital agreements are being signed every day using signatures that will one day be vulnerable to a quantum computer attack.

### II. The Value of Digital Agreements

Digital agreements have largely supplanted paper documents as the primary mechanism for attesting to the identities of signatories and the time of signing for modern legal agreements. A digital agreement might be loosely defined as an electronic document that records a transaction or agreement between multiple parties.

For a digital agreement to have legal status, there must be a recognized mechanism for establishing the consent of the parties involved in the agreement. The mechanism used in almost all cases is an electronic signature. Electronic signatures are supported by legal frameworks such as the EU eIDAS Regulation and the US 2000 Electronic Signatures in Global and National Commerce Act.

Digital agreements have the same value as their paper-based equivalents. In some cases, a digital agreement might represent chattel paper, which underpins the monetary value of a mortgage or lease. In the absence of the chattel paper (electronic or paper), the monetary value of the obligation cannot be established. Therefore, in some senses, the value of a chattel document is equivalent to the value of the monetary obligation. In other words, an electronic agreement evidencing a loan might be considered to have a value equivalent to the value of the loan.

As with paper agreements, digital agreements can span very long periods of time. For instance, home loans of 20-30 years are commonplace. For paper agreements, this created a motivation for safe storage, particularly for chattel documents. A similar requirement for secure long-term storage applies to digital agreements. Additionally, digital agreements with long timespans must consider the long-term viability of the electronic signature technologies that they employ.

### III. How Digital Agreements Work

A digital agreement is typically a document, such as a portable document format (PDF) document, into which a digital agreement vendor has inserted cryptographic signatures attesting to the participant's signatures and signing dates.

Typically, the author of the digital agreement will submit the unsigned version of the document to an electronic signature platform. The platform will contact all the required signatories and have them confirm they wish to sign the document. In the weakest but probably most common case, the platform authenticates a signatory by email—a signatory is considered to be someone in control of a specific email account. However, e-signature platforms may also use advanced methods, including a private key directly associated with the user's facial recognition or other biometric factors, to validate the user.

When all users have confirmed that they wish to sign the document, the platform will create a signed version of the agreement. This signed version contains details of the authentication mechanisms used and a signed cryptographic hash of the document. This hash is typically cryptographically signed using the e-signature platform's private key and can be validated by anybody utilizing the platform's public key.

The e-signature attests to the identities, consent and dates of the digital agreement. So, how does someone looking at such a digital agreement know that the signature is really from the signing party or—more frequently—the signing platform? The answer lies in the chain of trust security model, which is the foundation of online trust and is incorporated in all web browsers and most PDF viewers.

The Chain of trust allows verification of a digital signature by reference to a trusted Certificate Authority (CA) such as GlobalSign, DigiCert or EnTrust. The “root” certificates for these trusted entities are pre-installed in most operating systems and web browsers and are implicitly trusted by the software. The digital certificate of the e-signature vendor is signed by this root certificate or, more commonly, by an intermediate certificate signed by the root certificate. The “chain” of certificates allows you to trust the certificate of the signing party, providing you trust the root certificate of the CA.

This “chain of trust” underpins most of the everyday privacy and security of the modern internet and is one of the foundations of the Web. However, these mechanisms may have vulnerabilities over the long term that need to be addressed if there is to be confidence in the long-term validity of digital documents.

### A. Qualified Signatures

In the case of a qualified signature, the signer will typically use a private key to which they have exclusive control to sign the document. This is done either by using a qualified signature creation device and/or a qualified trust service provider. The device or the service provider holds an encrypted private key for the user and can use that key to sign a digital document. The chain of trust referenced earlier allows anybody to verify the signature, providing they trust the root certificate from the Certificate Authority.

### B. Qualified Timestamps

RFC3161 defines a mechanism for obtaining timestamps from trusted TimeStamp Authorities. These “qualified timestamps” can be used to assert the existence of a digital signature on a certain date. However, it's worth noting that the signatures themselves are not cryptographic proofs of timestamps. Rather, they are date fields appended to the document and signed using PKI by a trusted entity. RFC3161 timestamps are discussed later in this document.

### IV. The Quantum Threat to Digital Agreements

The previous section outlines the technical basis for e-signatures. It should be apparent from that discussion that the validity of an e-signature is dependent on the integrity of all the digital certificates in the chain of trust. Most significantly, should the private key that forms the basis for the CA root certificate be exposed, thousands or even millions of digital agreements could be rendered void.

While it may not be feasible to anticipate all possible future threats to cryptographic technologies, as recognized herein, one emerging technology that poses an existential risk to today's cryptography—Quantum computing.

The security of the private/public key system is based on the computational impracticality of factoring large numbers into their prime factors (e.g. for RSA) and on solving similar computationally expensive problems (e.g. for DSA, ECDSA). In theory, a computer could calculate the private key associated with any public key by finding a large number with a common factor to the public key or by solving another hard mathematical problem. Although this is possible, the complexity of the mathematics means that it would potentially take a traditional computer millions of billions of years to find a solution if the key length is sufficiently large.

In a Quantum computer, operations can be performed on large numbers of discrete values simultaneously because the “qubits”—which are the equivalent of bits in a classical computer—are in a superposition of all possible states. It has been theoretically and practically demonstrated that a sufficiently powerful Quantum computer could derive a private key from a public key almost instantaneously.

The threat to today's cryptographic signatures schemes and PKI infrastructure is that there will one day be a quantum computer with sufficient stable qubits to break the hard underlying mathematical problems on which these signature schemes are built (factoring and discrete logarithm). When that happens, it will be feasible to compute the private key associated with a given public key. For example, today the most performant quantum algorithm to factor large numbers would be able to break an RSA key of 2048 bits with 372 stable qubits.

The threat to today's PKI cryptography is that there will one day be a quantum computer with sufficient stable qubits to break an RSA public key. When that happens, the private key associated with the public key could be revealed. How many qubits would be required depends on the algorithm employed, but by some estimates, only 372 stable qubits would be required to break an RSA2048 certificate. At that point, the cryptographic basis for most of today's digital certificates will disappear.

The owner of an individual agreement might feel that the chance of an attacker using a quantum computer just to invalidate their specific agreement is low, and that is probably correct. However, it is also irrelevant. Once sufficiently powerful Quantum computers are widely available (probably “as a service” on the cloud), hackers will inevitably attack the root certificates, which protect not just digital agreements but also real-time web traffic. Once these certificates are broken, it will be impossible to prove that a digital agreement based on that root certificate is valid. A single root certificate failure could potentially invalidate millions or even billions of digital agreements.

Estimates of how proximity to Q-Day (the day a quantum computer can break today's private keys) vary. Few experts think such a computer will exist within five years, though many feel it may be less than ten years away. What is certain is that many billions of dollars are being spent to perfect quantum computing, and if the history of computing is any guide, progress will only accelerate.

For a short-lived digital agreement—an exploratory NDA perhaps—the risk from quantum computing may be negligible. But for a long-term, high-value digital agreement—a mortgage or loan, for instance—the chance that Q-Day will arrive before the end of the agreement lifespan may be too high.

### V. Creating Quantum-Safe Digital Agreements Now

Work is already underway to standardize on quantum-safe asymmetric cryptographic algorithms that can be used as the basis for quantum-safe digital signatures. However, integrating these algorithms—when they are finalized—into the Public Key Infrastructure while maintaining interoperability with all existing schemes is likely to be a multi-year project. In the meantime, millions of digital signatures are being signed every month using quantum-vulnerable algorithms.

Advantageously, in certain aspects, it is unnecessary to wait for the rollout of quantum-safe algorithms to protect today's digital agreements. Combining today's PKI-based signatures with immutable, quantum-safe, and arguably unhackable, blockchain transactions, can protect the cryptographic validity of any e-signature.

### A. Quantum-Safe and Un-Hackable Digital Fingerprints

The asymmetric (public/private key) schemes used by e-signature vendors are vulnerable to hacking and quantum attacks. However, there are alternative approaches that can withstand any quantum attack.

Cryptographic hash functions create a hash signature of a document such that it is practically impossible to create a different document that generates an identical hash (pre-image resistance) and, therefore, practically impossible to create two documents that generate the same hash (collision resistance).

Cryptographic hash functions such as SHA-2 and SHA-3 are not susceptible to quantum computing attacks. Therefore, if we can establish the existence of a certain hash value and cryptographically anchor it in time, we can prove beyond doubt the integrity and existence of a document at a certain point in time, even in the post-quantum computing era.

The use of a trusted TimeStamp Authority (TSA) to attach a timestamp to a cryptographic hash might be thought of as a solution to the problem. However, TSA signatures themselves are based on PKI and are, therefore, as vulnerable to quantum attack as the signatures they seek to protect. Additionally, a TSA timestamp offers no objective cryptographic proof of the timestamp—we have to take on faith that the timestamp supplied by the TSA server has not been manipulated. TSA timestamps also expire and may have to be periodically resigned to maintain validity.

### B. Blockchain or DLT-Based Timestamps

Blockchains (sometimes referred to as Distributed Ledger Technology [DLT]) provide an immutable record of transactions that cannot be altered by any known practical technology. Although almost all blockchains need to migrate their authentication systems before the emergence of a quantum computer, historical blockchain records are quantum-safe.

Blockchains represent an immutable ledger that is designed to allow for distributed transactions to be performed in the absence of a trusted third party. These trustless transactions are protected by the blockchain network itself using a variety of algorithms that would prevent a malicious actor from falsifying cryptocurrency transactions. The internals of how this is achieved is beyond the scope of this disclosure, but it is worth noting that the Bitcoin blockchain holds a total value of more than half a trillion US Dollars, and to date, there has not been any successful attack on the blockchain itself.

Blockchain records the time of each transaction within the immutable distributed ledger and, in almost all cases, allows a note field (e.g., memo) to be associated with the transaction. This note can contain a hash value, and therefore, we can place a hash on a blockchain and thereby establish a definitive timestamp for that hash.

Blockchain authentication does rely on public/private key pairs using the same algorithms as PKI, and all blockchains will need to migrate to quantum-safe algorithms prior to Q-Day. However, the integrity of historical records in the blockchain is not in any way dependent on these authentication mechanisms. A block in a public blockchain is anchored to preceding blocks using a Merkle tree of cryptographic hashes (e.g., SHA-2), which incorporate the hashes of all the transactions in the previous block (or blocks in the case of graph-oriented ledgers). Creating a phony blockchain transaction record would require that the attacker recreate the entire blockchain forward in time from the transaction entry. Even if such an attempt were somehow computationally within reach of an attacker (e.g., a powerful nation-state adversary), the existing blockchain network would reject the substitution of deep historical blocks, and the result would be a denial-of-service attack at best.

The longer the time that has passed since the transaction, the harder it becomes for any attacker to “rewrite history”. So unlike conventional cryptography, in which older cryptographic proofs are more vulnerable, the older the blockchain transaction, the harder it is to falsify. And while electronic signature certificates will always expire, blockchain transactions will never expire.

Therefore, a cryptographic hash of a signed digital agreement placed on a public blockchain can constitute absolute proof of the agreement's existence at a specific date and rule out any fabrication using compromised digital certificates after that date.

### C. Aggregation of Blockchain Signatures

The use of a dedicated blockchain signature for every signed document would be impractical due to the scalability and economics of most blockchains. Blockchain transactions involve transaction fees that are higher than the signing costs charged by most e-signature vendors. Furthermore, the absolute transaction limits and latencies imposed by some blockchains would be insufficient to support the current volumes of digital signatures routinely processed today.

Consequently, it's desirable to aggregate multiple digital signature hashes in a single blockchain transaction. This can be done by employing Merkle trees and Merkle paths. A Merkle tree consists of a series of hash pairs that aggregate large numbers of leaf hashes into a single root hash. This root hash can be used as the payload of the blockchain transaction. Providing one maintains a record of the hash pairs between the leaf hashes and the root hash (the Merkle path), one can prove that a leaf node hash was included within the root hash.

### D. Cross-Chain Rollups

The use of Merkle trees can help overcome the economic and throughput limits imposed by public blockchains but can't change the delays and latencies involved in finalizing individual transactions. The larger public blockchains, such as Ethereum and Bitcoin, have significantly higher latencies than some of the “L2” and permissioned chains, such as Polygon or Hashgraph.

However, as slow as the larger blockchains may be, the economic value and hashing power involved in these chains means that transactions stored on these chains have the lowest risk and highest possible credibility. It's unclear where some of the L2 chains will be in 10 years'time, but there's no doubt that Ethereum and Bitcoin will persevere.

To achieve the best balance between latency and longevity, we can employ a variation on the aggregation scheme outlined in the previous section. The immediate hash from an individual transaction might find its way onto a high-speed chain such as Hashgraph within minutes. Periodically—once a day perhaps—a Merkle tree of these transactions could be created and posted to one of the major chains, such as Ethereum.

E. Embedding Blockchain Certificates in Documents (e.g., PDFS) using Protocols such as RFC3161

RFC3161 defines a mechanism for obtaining timestamps from trusted TimeStamp Authorities. These timestamps can be embedded in PDF documents as additional signatures that attest to the signature date of the agreement. These timestamp signatures are not cryptographic proof of time, nor are they in any way resistant to quantum attacks.

However, the standard provides a mechanism whereby timestamp information can be embedded into a signed PDF document. An RFC3161 signature can include additional “extension” data into which we can insert the Merkle path and other metadata that would allow for the blockchain transaction that establishes the document timestamp to be identified without having to access a separate database of blockchain transaction information.

### F. Protecting Existing Agreements

The mechanisms outlined above are designed to be deployed within an integrated e-signature platform, and obviously, the closer the blockchain transaction is to the signing date, the better.

However, there is no reason why existing documents cannot be protected from quantum attack. Provided a blockchain signature is created prior to the expiration of the digital certificate or Q-Day, then it will be possible to use that signature to prove that the digital signature was created prior to Q-Day or the expiration of any of the chain of trust certificates used to create the signature and therefore to establish the agreement's validity into the future.

### G. PAdES-B-LTA

The PDF Advanced Electronic Signatures Standard (PAdES) defines various levels of digital signature compliance. The highest level PAdES-B-LTA is intended for digital signatures where the signing date must be cryptographically provable and which can survive the expiration or invalidation of timestamp and signing certificates. PAdES-B-LTA requires periodic resigning using timestamp servers even after initial certificates have expired or the signing methods are deemed weak.

The blockchain techniques outlined here meet the requirements of the PAdES-B-LTA requirements. Since the blockchain-based timestamps do not expire, from a cryptographic point of view, periodic resigning is not necessary.

### VI. Example Advantages of Principles Described Herein

By enabling digital agreements, today's e-signature technology has allowed us to execute business, public and personal agreements with greater efficiency, convenience and security. However, it needs to be recognized that today's technology cannot guarantee the validity of a digital agreement over extended time frames. For digital agreements that need to stand the test of time, a solution that combines traditional digital signature technology with quantum-safe, un-hackable timestamping—such as can be provided only by blockchains—is required. In certain aspects, various implementations described herein can combine traditional e-signature technology with blockchain technology to create durable, long-term digital agreements.

### VII. Example Systems and Methods

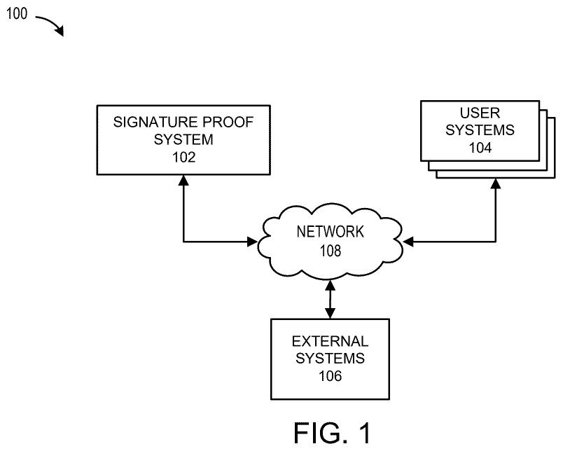

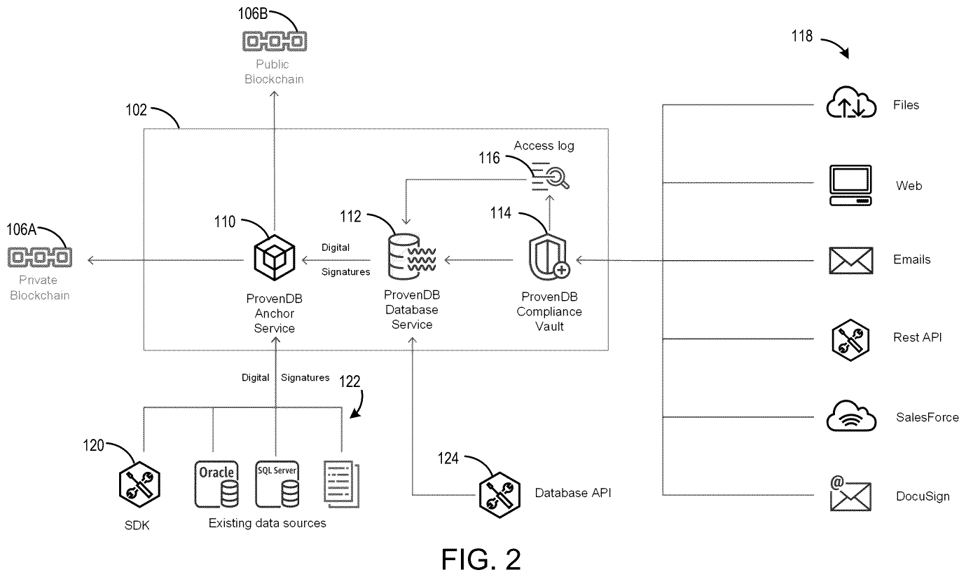

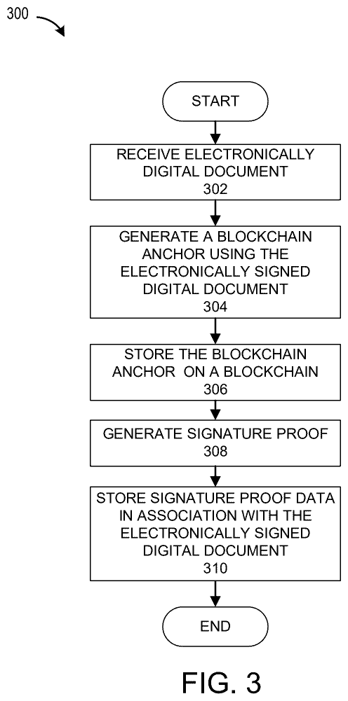

FIG. 1 illustrates an example of a system 100 for implementing a signature proof system 102. The system 100 includes the signature proof system 102, one or more user systems 104, and one or more external systems 106, each of which is operable to communicate over a network 108. The network 108 may be, or may include, one or more of a private network, a public network, a local or wide area network, a portion of the Internet, combinations of the same, and/or the like. Example operation of the signature proof system 102 will be described in greater detail relative to FIGS. 2 and 3.

The external systems 106 can include any system with which the signature proof system 102 is operable to communicate to achieve its functionality. For example, the external systems 106 can include blockchain systems that provide access to a public or private blockchain.

In certain embodiments, features of the components of signature proof system 102 can be made accessible over an interface to the user systems 104. The user systems 104 can include any type or combination of computing device, including desktops, laptops, tablets, smartphones, and wearable or body-borne computers such as smartwatches or fitness trackers, to name a few. The user systems 104 can be operated by users, such as customers to be on-boarded, or by other users, for example, for administration purposes.

FIG. 2 illustrates an example of the signature proof system 102. In the illustrated embodiment, the signature proof system 102 includes an anchor service 110, a database service 112, a compliance vault 114, and an access log 116. Each of these components can be implemented with hardware and/or software, including (optionally) virtual machines and containers. In an example, the signature proof system 102 can be implemented as a single management server. In another example, signature proof system 102 can be implemented in a plurality of virtual or physical servers, which may or may not be geographically co-located. In some embodiments, the signature proof system 102 may be hosted on a cloud-provider system. It should be appreciated, however, that the arrangement shown in FIG. 2 is only presented for illustrative purposes. After a thorough review of the present disclosure, one skilled in the art will appreciate that similar functionality can be distributed to any suitable number or arrangement of components.

The database service 112 is operable to configurably store data received, used, or generated by the signature proof system 102. The database service 112 can provide a database API 124 for purposes of accessing, retrieving, or manipulating the data stored thereby. In the illustrated embodiment, the database service 112 can store and maintain, for example, the compliance vault 114 and the access log l16 associated therewith. The compliance vault 114 can include a configurable set of compliance-relevant information in correspondence to a given organization's information governance policy. As illustrated, the compliance-relevant information stored in the compliance vault 114 can result from heterogeneous information sources 118 that may be available to an organization. In a typical embodiment, the database service 112 updates the access log 116 to track each access to information in the compliance vault 114.

The anchor service 110 can receive data, such as digital signatures, from the database service 112 and/or from various existing data sources 122 utilized by the signature proof system 102. The anchor service 110 can also post data, for example, to a private blockchain 106A and/or a public blockchain 106B such as Ethereum or Hedera Hashgraph. In some embodiments, as shown, the anchor service 110 can advantageously integrate various software development kits (SDKs) 120 to provide certain of its functionality, such as validation functionality in some embodiments. Example operation of the signature proof system 102 will be described in greater detail relative to FIG. 3.

FIG. 3 illustrates an example of a process 300 for cryptographically proving a time of signature of one or more electronically signed digital documents. In certain embodiments, the process 300 can be implemented by any system that can process data. Although any number of systems, in whole or in part, can implement the process 300, to simplify discussion, the process 300 will be described generally relative to the signature proof system 102 of FIGS. 1-2.

At block 302, the signature proof system 102 receives an electronically signed digital document for a signature proof. The electronically signed digital document can be, for example, a signed digital agreement as discussed above in Section III. In some aspects, the electronically signed digital document can be received, for example, from a user operating one of the user systems 104 of FIG. 1. In certain aspects, the block 302 can include receiving a plurality of electronically signed digital documents for aggregate handling by the signature proof system 102. For simplicity of description, the process 300 will be described relative to a single electronically signed digital document. It should be appreciated, however, that blocks 304-310 discussed below can be performed relative to each of a plurality of documents.

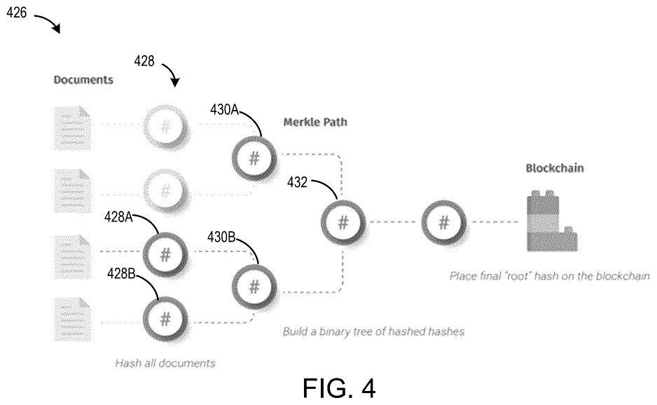

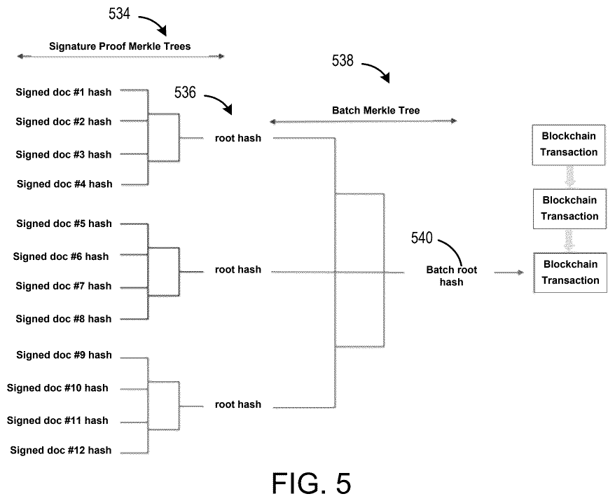

At block 304, the signature proof system 102 generates a blockchain anchor using the electronically signed digital document. The blockchain anchor can represent at least a portion of the electronically signed digital document.. In some embodiments, the blockchain anchor can be a cryptographic hash that is generated using SHA-2, SHA-3, or another suitable hashing algorithm. For example, in some cases, the cryptographic hash can result from hashing the electronically signed digital document. In some aspects, additional hashing can be performed to generate the cryptographic hash. For example, the cryptographic hash can be a root of a Merkle tree, thereby resulting from a sequence of hashes. Example embodiments involving Merkle trees will be described in greater detail relative to FIGS. 4 and 5.

At block 306, the signature proof system 102 stores the blockchain anchor on a blockchain in a blockchain transaction. For example, if the blockchain anchor is a cryptographic hash as described relative to the block 304, the block 306 can include storing that cryptographic hash on the blockchain. The blockchain can be, for example, a public blockchain such as the public blockchain 106B of FIG. 2. In certain aspects, the blockchain anchor can be placed, for example, in a note field (e.g., memo), as discussed above.

At block 308, the signature proof system 102 generates a signature proof that certifies an existence of the electronically signed digital document at a time associated with the blockchain transaction, such as a time associated with the blockchain transaction (e.g., a time of the blockchain transaction). The signature proof can include, for example, a unique identifier for the blockchain transaction and the time associated with the blockchain transaction. In some embodiments, the signature proof can be, or can include, a human-readable certificate that explains cryptographic techniques involved and includes binary representations of such proofs.

In some embodiments, the block 308 can include creating a uniform resource locator (URL), such as a permanent URL, and associating the URL with the signature proof. In these embodiments, the URL can be used to share the signature proof and/or documents related thereto, such as the electronically signed digital document. The URL allows owners, for example, to share the signature proof and/or documents related thereto, such as the electronically signed digital document, with other parties. In various embodiments, the URL translates to a page that shows the signature proof and/or documents related thereto, such as the electronically signed digital document, and their cryptographic proofs.

At block 310, the signature proof system 102 stores signature proof data in association with the electronically signed digital document. In general, the block 324 can include the database service 112 of FIG. 2, for example, storing any data received, generated, or used during the process 300. The stored signature proof data can include, for example, all or part of the signature proof from the block 308, the electronically signed digital document received from the user, hashed and/or digitally signed representations of any of the foregoing, the blockchain anchor from the block 304, combinations of the same, and/or the like. In some cases, as described in greater detail below relative to FIGS. 4 and 5, the stored signature proof data can include Merkle path information for the blockchain anchor.

In certain aspects, the storing at the block 310 can include, for example, embedding the signature proof data in the electrically signed digital document. For example, in some of these aspects, the storing can involve, for example, creating stenographic and/or watermarked versions of the electronically signed digital document.

In certain embodiments, the storing at the block 310 can include, for example, storing the signature proof data in an archive format that encapsulates the signature proof data together with the electronically signed digital document and/or metadata. This archive can include, for example, the electronically signed digital document, stenographic and/or watermarked versions of these documents, hashed and/or digitally signed representations of any of the foregoing (e.g., signed with a private key of the signature proof system 102), the blockchain anchor, metadata (e.g., in JSON format), Merkle trees and/or Merkle paths associating all elements with their ultimate blockchain transaction identifiers, a human-readable certificate explaining the cryptographic techniques involved and which also includes binary representations of these proofs, combinations of the foregoing and/or the like. Merkle trees and paths can be provided, for example, in Chainpoint format such that Merkle proofs can be independently verified using Chainpoint APIs. After block 310, the process 300 ends.

FIG. 4 illustrates an example of a Merkle tree 426 that can be utilized in some embodiments. The Merkle tree 426 is a data structure that, in some embodiments, can be used within a blockchain to anchor multiple elements in one block to a single “signature” in a succeeding block. The Merkle tree 426 has a root node 432. For simplicity of description, nodes of Merkle trees may be periodically referenced herein by the hashes they contain (e.g., leaf hash, root hash, etc.).

With reference to the process 300 of FIG. 3 described above, in some embodiments, the blockchain anchor that is stored on blockchain can each be a root hash of a Merkle tree. For example, in the Merkle tree 426 shown in FIG. 4, multiple elements, such as multiple electronically signed digital documents or other data, are hashed, and the hash of each element is placed in leaf nodes 428 of the Merkle tree 426. Pairs of the leaf nodes 428 are hashed, and then pairs of those hashes are hashed, and so on until only the root node 432 remains. The root node 432 can be used to prove any or all of the elements concerned.

Although it might be unwieldy if the entire Merkle tree 426 were required to prove an individual element represented in the leaf nodes 428, in various embodiments, an element, such as an electronically signed digital document, can be proved by supplying only a Merkle path, where the Merkle path is defined by the sequence of hash pairs that connect a given leaf hash representing that element with the root hash. For example, with reference to the leaf node 428a, a Merkle path would include leaf nodes 428A and 428B and intermediate nodes 430A and 430B. In this way, the signature proof data that is stored at the block 310 of FIG. 3 can include Merkle path information for each node that is to be individually provable, such as for all the leaf nodes. The Merkle path information can include, for example, for each leaf node, the sequence of hash pairs that connect the leaf node with the root node.

In various embodiments, Merkle trees can be used to aggregate data related to multiple signature proof requests, and/or multiple electronically signed digital documents, into a single blockchain transaction. For some blockchains (e.g., Ethereum), the cost of a transaction can vary significantly from time to time. A solution that required a blockchain transaction for each signature proof request could be uneconomical in some cases. Therefore, in certain embodiments, the signature proof system 102 aggregates multiple signature proof requests, and/or multiple electronically signed digital documents, into a single blockchain transaction. Any signature proof request, for example, can aggregate multiple electronically signed digital documents into a single hash which are then aggregated into a batch Merkle tree, thereby creating a final root hash that is inserted onto the public blockchain, for example. The batch root hash can therefore prove hundreds or thousands of electronically signed digital documents, for example.

FIG. 5 illustrates an example of a batch Merkle tree 538. The batch Merkle tree 538 is constructed from signature proof Merkle trees 534. The signature proof Merkle trees 534 can each be constructed from individual elements, such as documents or other data or metadata, for a given signature proof request. Advantageously, in certain embodiments, the signature proof Merkle trees 534 can relate to different signature proof requests and different users, although that need not always be the case. For illustrative purposes, the signature proof Merkle trees 534 are shown to be three in number, but it should be appreciated that the signature proof Merkle trees 534 can include any suitable number of signature proof Merkle trees, such as many hundreds or thousands. The signature proof Merkle trees 534 have signature proof root hashes 536, one for each of the signature proof Merkle trees therein. The signature proof root hashes 536 can be created in similar fashion to the root node 432 described relative to FIG. 4.

The batch Merkle tree 538 is constructed by hashing the signature proof root hashes 536, thereby resulting in a batch root hash 540. With reference to the process 300 of FIG. 3 described above, in some embodiments, the first and second anchors that are stored on the public blockchain can each be a root hash of a batch Merkle tree similar to the batch root hash 540 of the batch Merkle tree 538. A single blockchain transaction can thus serve an anchoring function for multiple signature proof requests for multiple users. In this way, the signature proof data that is stored at the block 310 of FIG. 3 can include Merkle path information for each node that is to be individually provable, such as for all the leaf nodes. The Merkle path information can include, for example, for each leaf node, the sequence of hashes that connect the leaf node with the root node.

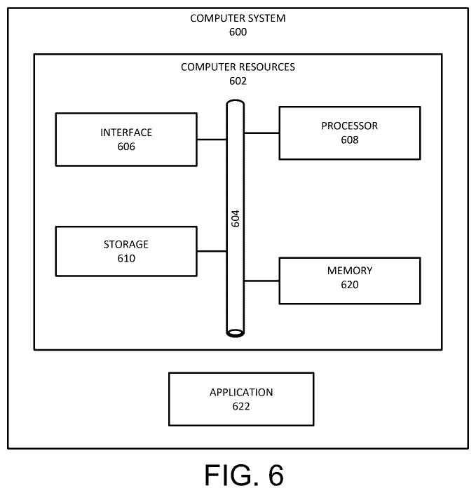

FIG. 6 illustrates an example of a computer system 600 that, in some cases, can be representative, for example, of the signature proof system 102 and/or a module or sub-component of the foregoing. The computer system 600 includes an application 622 operable to execute on computer resources 602. The application 622 can be, for example, any of the systems or modules illustrated in FIG. 1 or 2. In particular embodiments, the computer system 600 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the computer system 600 may comprise any suitable physical form, configuration, number, type and/or layout. As an example, and not by way of limitation, the computer system 600 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 600 may include one or more computer systems; be unitary or distributed; span multiple locations; span multiple machines; or reside in a cloud, which may include one or more cloud components in one or more networks.

In the depicted embodiment, the computer system 600 includes a processor 608, memory 620, storage 610, interface 606, and bus 604. Although a particular computer system is depicted having a particular number of particular components in a particular arrangement, this disclosure contemplates any suitable computer system having any suitable number of any suitable components in any suitable arrangement.

Processor 608 may be a microprocessor, controller, or any other suitable computing device, resource, or combination of hardware, software and/or encoded logic operable to execute, either alone or in conjunction with other components, (e.g., memory 620), the application 622. Such functionality may include providing various features discussed herein. In particular embodiments, processor 608 may include hardware for executing instructions, such as those making up the application 622. As an example, and not by way of limitation, to execute instructions, processor 608 may retrieve (or fetch) instructions from an internal register, an internal cache, memory 620, or storage 610; decode and execute them; and then write one or more results to an internal register, an internal cache, memory 620, or storage 610.

In particular embodiments, processor 608 may include one or more internal caches for data, instructions, or addresses. This disclosure contemplates processor 608 including any suitable number of any suitable internal caches, where appropriate. As an example, and not by way of limitation, processor 608 may include one or more instruction caches, one or more data caches, and one or more translation lookaside buffers (TLBs). Instructions in the instruction caches may be copies of instructions in memory 620 or storage 610 and the instruction caches may speed up retrieval of those instructions by processor 608. Data in the data caches may be copies of data in memory 620 or storage 610 for instructions executing at processor 608 to operate on; the results of previous instructions executed at processor 608 for access by subsequent instructions executing at processor 608, or for writing to memory 620, or storage 610; or other suitable data. The data caches may speed up read or write operations by processor 608. The TLBs may speed up virtual-address translations for processor 608. In particular embodiments, processor 608 may include one or more internal registers for data, instructions, or addresses. Depending on the embodiment, processor 608 may include any suitable number of any suitable internal registers, where appropriate. Where appropriate, processor 608 may include one or more arithmetic logic units (ALUs); be a multi-core processor; include one or more processors 608; or any other suitable processor.

Memory 620 may be any form of volatile or non-volatile memory including, without limitation, magnetic media, optical media, random access memory (RAM), read-only memory (ROM), flash memory, removable media, or any other suitable local or remote memory component or components. In particular embodiments, memory 620 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 620 may include one or more memories 620, where appropriate. Memory 620 may store any suitable data or information utilized by the computer system 600, including software embedded in a computer readable medium, and/or encoded logic incorporated in hardware or otherwise stored (e.g., firmware). In particular embodiments, memory 620 may include main memory for storing instructions for processor 608 to execute or data for processor 608 to operate on. In particular embodiments, one or more memory management units (MMUs) may reside between processor 608 and memory 620 and facilitate accesses to memory 620 requested by processor 608.

As an example, and not by way of limitation, the computer system 600 may load instructions from storage 610 or another source (such as, for example, another computer system) to memory 620. Processor 608 may then load the instructions from memory 620 to an internal register or internal cache. To execute the instructions, processor 608 may retrieve the instructions from the internal register or internal cache and decode them. During or after execution of the instructions, processor 608 may write one or more results (which may be intermediate or final results) to the internal register or internal cache. Processor 608 may then write one or more of those results to memory 620. In particular embodiments, processor 608 may execute only instructions in one or more internal registers or internal caches or in memory 620 (as opposed to storage 610 or elsewhere) and may operate only on data in one or more internal registers or internal caches or in memory 620 (as opposed to storage 610 or elsewhere).

In particular embodiments, storage 610 may include mass storage for data or instructions. As an example, and not by way of limitation, storage 610 may include a hard disk drive (HDD), a floppy disk drive, flash memory, an optical disc, a magneto-optical disc, magnetic tape, or a Universal Serial Bus (USB) drive or a combination of two or more of these. Storage 610 may include removable or non-removable (or fixed) media, where appropriate. Storage 610 may be internal or external to the computer system 600, where appropriate. In particular embodiments, storage 610 may be non-volatile, solid-state memory. In particular embodiments, storage 610 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 610 may take any suitable physical form and may comprise any suitable number or type of storage. Storage 610 may include one or more storage control units facilitating communication between processor 608 and storage 610, where appropriate.

In particular embodiments, interface 606 may include hardware, encoded software, or both providing one or more interfaces for communication (such as, for example, packet-based communication) among any networks, any network devices, and/or any other computer systems. As an example, and not by way of limitation, communication interface 606 may include a network interface controller (NIC) or network adapter for communicating with an Ethernet or other wire-based network and/or a wireless NIC (WNIC) or wireless adapter for communicating with a wireless network.

Depending on the embodiment, interface 606 may be any type of interface suitable for any type of network for which computer system 600 is used. As an example, and not by way of limitation, computer system 600 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 600 may include any suitable interface 606 for any one or more of these networks, where appropriate.

In some embodiments, interface 606 may include one or more interfaces for one or more I/O devices. One or more of these I/O devices may enable communication between a person and the computer system 600. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 606 for them. Where appropriate, interface 606 may include one or more drivers enabling processor 608 to drive one or more of these I/O devices. Interface 606 may include one or more interfaces 606, where appropriate.

Bus 604 may include any combination of hardware, software embedded in a computer readable medium, and/or encoded logic incorporated in hardware or otherwise stored (e.g., firmware) to couple components of the computer system 600 to each other. As an example, and not by way of limitation, bus 604 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 604 may include any number, type, and/or configuration of buses 604, where appropriate. In particular embodiments, one or more buses 604 (which may each include an address bus and a data bus) may couple processor 608 to memory 620. Bus 604 may include one or more memory buses.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 608 (such as, for example, one or more internal registers or caches), one or more portions of memory 620, one or more portions of storage 610, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments, are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method of cryptographically proving a time of signature, the method comprising, by a computer system:
receiving an electronically signed digital document;
generating a cryptographic hash using at least a portion of the electronically signed digital document;
storing the cryptographic hash on a blockchain in a blockchain transaction; and
storing, in association with the electronically signed digital document, a certification of an existence of the electronically signed digital document at a time associated with the blockchain transaction.

2. The method of claim 1, wherein the storing the cryptographic hash comprises storing the cryptographic hash in a note field associated with the blockchain transaction.

3. The method of claim 1, wherein the storing the certification comprises embedding the certification in the electronically signed digital document.

4. The method of claim 1, wherein the generating the cryptographic hash comprises:
hashing data comprising the at least a portion of the electronically signed digital document; and
constructing a Merkle tree at least partly from the hashed data, the stored cryptographic hash comprising a root hash of the Merkle tree.

5. The method of claim 4, wherein the Merkle tree comprises a batch Merkle tree, the constructing the Merkle tree comprising hashing data related to multiple electronically signed digital documents.

6. The method of claim 4, wherein the storing the certification comprises storing Merkle path information for at least one node of the Merkle tree, the Merkle path information comprising information related to a sequence of hashes that connect the at least one node with the root hash of the Merkle tree.

7. The method of claim 1, wherein the blockchain comprises a public blockchain.

8. A computer system comprising a processor, persistent storage and memory, which in combination are operable to implement a method of cryptographically proving a time of signature:
receiving an electronically signed digital document;
generating a cryptographic hash using at least a portion of the electronically signed digital document;
storing the cryptographic hash on a blockchain in a blockchain transaction; and
storing, in association with the electronically signed digital document, a certification of an existence of the electronically signed digital document at a time associated with the blockchain transaction.

9. The computer system of claim 8, wherein the storing the cryptographic hash comprises storing the cryptographic hash in a note field associated with the blockchain transaction.

10. The computer system of claim 8, wherein the storing the certification comprises embedding the certification in the electronically signed digital document.

11. The computer system of claim 8, wherein the generating the cryptographic hash comprises:
hashing data comprising the at least a portion of the electronically signed digital document; and
constructing a Merkle tree at least partly from the hashed data, the stored cryptographic hash comprising a root hash of the Merkle tree.

12. The computer system of claim 11, wherein the Merkle tree comprises a batch Merkle tree, the constructing the Merkle tree comprising hashing data related to multiple electronically signed digital documents.

13. The computer system of claim 11, wherein the storing the certification comprises storing Merkle path information for at least one node of the Merkle tree, the Merkle path information comprising information related to a sequence of hashes that connect the at least one node with the root hash of the Merkle tree.

14. The method of claim 8, wherein the blockchain comprises a public blockchain.

15. A computer-program product comprising a non-transitory computer-usable medium having computer-readable program code embodied therein, the computer-readable program code adapted to be executed to implement a method of cryptographically proving a time of signature comprising:
receiving an electronically signed digital document;
generating a cryptographic hash using at least a portion of the electronically signed digital document;
storing the cryptographic hash on a blockchain in a blockchain transaction; and
storing, in association with the electronically signed digital document, a certification of an existence of the electronically signed digital document at a time associated with the blockchain transaction.

16. The computer-program product of claim 15, wherein the storing the cryptographic hash comprises storing the cryptographic hash in a note field associated with the blockchain transaction.

17. The computer-program product of claim 15, wherein the storing the certification comprises embedding the certification in the electronically signed digital document.

18. The computer-program product of claim 15, wherein the generating the cryptographic hash comprises:
hashing data comprising the at least a portion of the electronically signed digital document; and
constructing a Merkle tree at least partly from the hashed data, the stored cryptographic hash comprising a root hash of the Merkle tree.

19. The computer-program product of claim 18, wherein the Merkle tree comprises a batch Merkle tree, the constructing the Merkle tree comprising hashing data related to multiple electronically signed digital documents.

20. The computer-program product of claim 18, wherein the storing the certification comprises storing Merkle path information for at least one node of the Merkle tree, the Merkle path information comprising information related to a sequence of hashes that connect the at least one node with the root hash of the Merkle tree.
